(19) United States
(12) Patent Application Publication
(10) Pub. No.: US 2007/0239501 A1
(43) Pub. Date: Oct. 11, 2007

(54) Methods, systems, and media for creating a collaboration space using information from an enterprise resource planning system

(75) Inventors: Adrian Cunningham, Belfast (GB); Alan R. Gilmore, Holywood (GB); Tony Ogilvie, Newtownabbey (IE); Matt Winstanley, Stafford, VA (US)

Correspondence Address: WILMER CUTLER PICKERING HALE AND DORR LLP, 399 PARK AVENUE, NEW YORK, NY, 10022, US

(73) Assignee: Meridio Ltd., Belfast (GB)

(21) Appl. No.: 11/603,682

(22) Filed: Nov. 22, 2006

Related U.S. Application Data
(60) Provisional application No. 60/739,348, filed on Nov. 23, 2005.

(51) Int. Cl. G06Q 10/00

(52) U.S. Cl. 705/7

(57) ABSTRACT

Methods, systems, and media for creating a collaboration space using information from an enterprise resource planning system are provided. In some embodiments, methods for creating a collaboration space using information from an Enterprise Resource Planning (ERP) system are provided, the methods comprising: defining at least one event to monitor in the ERP system; defining the information from the ERP system to be captured; defining actions to be applied to the information; and upon the occurrence of the at least one event, extracting the information from the ERP system and performing the actions on the information to create the collaboration space.

### CROSS-REFERENCE TO RELATED APPLICATION

This application claims the benefit of U.S. Provisional Patent Application No. 60/739,348, filed Nov. 23, 2005, which is hereby incorporated by reference herein in its entirety.

### TECHNICAL FIELD

The invention relates to Enterprise Resource Planning (ERP) systems and Electronic Document and Records Management (EDRM) systems. More particular, the invention relates to information exchange between ERP and EDRM systems.

### BACKGROUND

Enterprise Resource Planning (ERP) systems are often deployed by individuals or organizations to automate and/or centralize their internal systems governing, for example, manufacturing, logistics, distribution, invoicing, accounting and other functions. Because they may govern a substantial number of internal functions and may be spread over a wide geographic area, ERP systems are often extremely complex and difficult to set up and administer. In addition, ERP systems may be extremely expensive, often costing millions of dollars for a single ERP solution. Some of the currently existing ERP software vendors include SAP AG, Oracle and Siebel Systems.

One of the shortcomings of prior ERP systems results from the fact that they often tend to be geared towards organizations that manufacture physical goods or products, such as aircrafts, electronics, and the like. In particular, ERP systems are often quite rigid and are not adaptable to the specific workflow and business processes of companies in service-related, knowledge management, or intellectual capital businesses. In such cases, the primary output of the business is not goods but rather services and their related documents.

Organizations that wish to organize their documents often use an Electronic Document and Records Management (EDRM) system. Such systems are designed to organize electronic documents across an organization, whereby some control over the documents' creation, modification, and ultimate disposal may be maintained. Therefore, it is logical that an organization may seek to integrate an ERP system and an EDRM system. For example, such an organization may use an ERP system to manage the creation of customer accounts, the assignment of personnel to projects, management of project time and costs, and similar matters, and may use a separate EDRM system to handle the lifecycle of documents (e.g., reports, proposals, analyses, and the like which may generated in the course of a customer engagement).

Historically, the integration of ERP and EDRM systems has required a great deal of time, effort, and expense. An organization seeking to integrate disparate ERP and EDRM systems would need to determine what information or objects it wished to exchange between these systems. The organization may then, for example, create a detailed mapping structure describing where within the EDRM system the information or objects extracted from the ERP system should be placed, what controls should be placed on the information or objects, and similar items. The organization may then develop, test, and deploy a custom solution to accomplish this end. Ordinarily this kind of effort would require specialized knowledge of both systems, and may necessitate hiring specialists to accomplish the goal of integration. It would also require the creation of custom software code that would typically be rigid, inflexible, and difficult to repurpose should the informational needs of the organization change in the future.

There are several software packages currently available which might address a subset of this problem. These packages are currently aimed at the Enterprise Asset Management (EAM) market, and are intended primarily to handle the large numbers of documents associated with the manufacturing, sale, or distribution of large mechanical systems. These software packages are focused on ensuring the relevance and availability of construction, maintenance, and repair documentation for such systems and cannot easily be repurposed to provide the type of dynamic content management that is required, for example, by companies in the intellectual asset management or knowledge management industries.

Therefore, there exists then a need for a solution that can serve as a gateway between ERP systems and EDRM systems, where such systems are deployed by organizations whose primary output is not goods, such as intellectual asset or knowledge management driven organizations. Moreover, according to various embodiments, such a solution should be flexible and scalable, and should also be able to be deployed and managed with relatively little user intervention.

### SUMMARY

Methods, systems, and media for creating a collaboration space using information from an enterprise resource planning system are provided. In some embodiments, methods for creating a collaboration space using information from an Enterprise Resource Planning (ERP) system are provided, the methods comprising: defining at least one event to monitor in the ERP system; defining the information from the ERP system to be captured; defining actions to be applied to the information; and upon the occurrence of the at least one event, extracting the information from the ERP system and performing the actions on the information to create the collaboration space.

In some embodiments, systems for creating a collaboration space using information from an Enterprise Resource Planning (ERP) system are provided, the systems comprising: an interface to the ERP system; and a processor that: defines at least one event to monitor in the ERP system; defines the information from the ERP system to be captured; defines actions to be applied to the information; and upon the occurrence of the at least one event, extracts the information from the ERP system and performing the actions on the information to create the collaboration space.

In some embodiments, computer-readable media containing computer-executable instructions that, when executed by a processor, cause the processor to perform a method for creating a collaboration space using information from an Enterprise Resource Planning (ERP) system, the method comprising: defining at least one event to monitor in the ERP system; defining the information from the ERP system to be captured; defining actions to be applied to the information; and upon the occurrence of the at least one event, extracting the information from the ERP system and performing the actions on the information to create the collaboration space.

### BRIEF DESCRIPTION OF DRAWINGS

Additional embodiments of the invention, its nature and various advantages, will be more apparent upon consideration of the following detailed description, taken in conjunction with the accompanying drawings. It will be understood that the figures depict various embodiments of the present invention for purposes of illustration only. One skilled in the art will readily recognize from the discussion herein that alternative embodiments of the structures and methods illustrated herein may be employed without departing from the principles of the invention described herein:

FIG. 1 is a simplified illustration that is representative of various embodiments of the present invention;

FIG. 2 is a simplified illustration that is representative of various embodiments of the present invention in which an ERP system and an EDRM system are bridged for a manufacturer of aircrafts;

FIG. 3 is a simplified illustration that is representative of the manner in which various embodiments of the present invention may operate where the present invention is not responding to the specific creation of events/objects in the ERP system but rather is processing existing events/objects in batch mode; and

FIG. 4 is a simplified illustration that is representative of the manner in which an Import Service may inherit and manage document retention and disposal rules from an EDRM system and apply them to the documents or objects in the Collaboration Space according to various embodiments of the present invention.

### DETAILED DESCRIPTION

Methods, systems, and media are provided for extracting data and structural information from one or more Enterprise Resource Planning (ERP) systems. According to various embodiments, these methods, systems, and media may be used to create one or more collaboration spaces that will be used to manage information about objects in the ERP system which exist within an Electronic Document and Records Management (EDRM) system. Moreover, according to various embodiments, these methods, systems, and media may enable the EDRM system to manage information related to objects in the ERP system in a manner similar to the manner in which an EDRM system manages other electronic documents or records.

According to various embodiments as described herein, a Migration Solution is provided which monitors one or more ERP systems for the occurrence of one or more events defined by the user through a Migration Toolkit. Examples of such events include the addition or deletion of a customer account, modification of a customer record, and similar events within the ERP system.

For example, upon the occurrence of one or more defined events, the Migration Solution creates an XML-based file that corresponds to certain criteria defined in advance by the user (e.g., in one or more “Case Files”) through the Migration Toolkit. Upon the creation of a Case File, predefined rules for managing the information relating to the case (e.g., in one or more “Rules Files”) may be invoked. The rules provided in the Rules File determine the exact structure and characteristics of the collaboration space that is set up for each Case, and data from the Case File is used to populate the relevant collaboration space.

According to various embodiments, an Import Service receives both the Case File and the Rules File and performs several tasks. First, for example, it creates a “Collaboration Space” within the EDRM system based on the predefined information management rules from the Rules File, and then populates the relevant spaces with the data or objects contained in the Case File. The Import Service may then query the EDRM system for relevant content management information, related to the data that is in the Collaboration Space, and this information may be used by the Rules Engine as input to one or more rules.

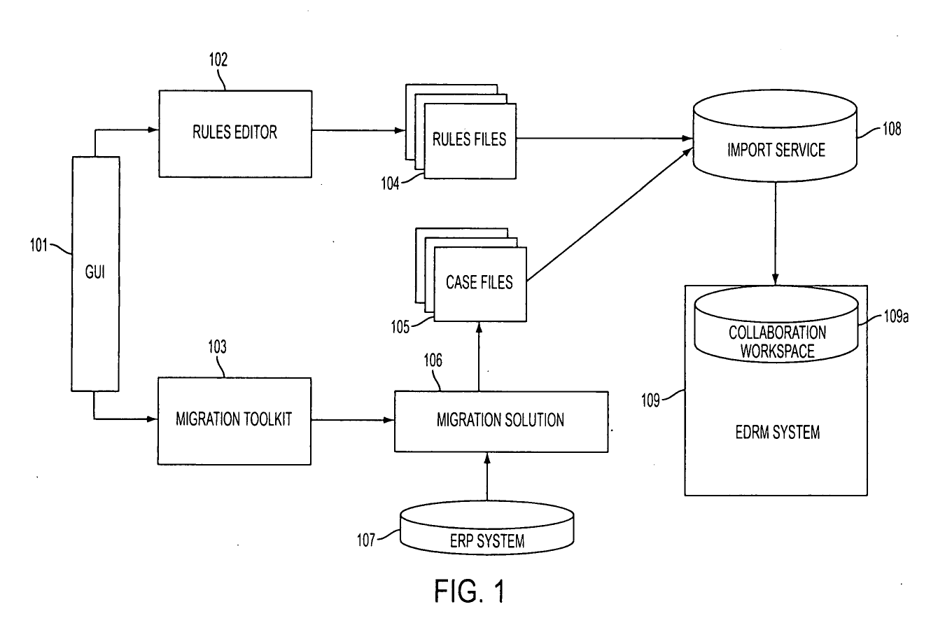

FIG. 1 is a simplified illustration that is representation of the invention in a generic form according to various embodiments of the present invention. In these embodiments, for example, an Administrator, through a Graphic User Interface 101, uses the Migration Toolkit 103 (e.g., a design-time tool) to create a Migration Solution 106 (e.g., a run-time element). The Migration Toolkit 103 in essence defines the behavior of the Migration Solution. It defines which ERP events and other information is to be captured, the format of the Case Files 105 (an example of which is illustrated in Appendix A), as well as any external input, such as a workflow that captures human input and/or any other orchestration or transformation to be performed on the data.

According to various embodiments, Migration Solution 106 includes a set of parameters describing which events or objects to monitor in ERP System 107. Examples of such events or objects that may be monitored by Migration Solution 106 are the creation of a new customer account, an order for a particular item (e.g., an oil rig, aircraft or the like), or the receipt of a Purchase Order within the ERP System 107. Similarly, Migration Solution 106 may be instructed to monitor ERP system 107 for changes in customer data, such as a name adjustment or the change in status of a given customer. Migration Solution 106 may also contain a set of instructions about what type of objects to extract from ERP System 107, and in what format these objects are to be packaged. This format may be Extensible Markup Language (XML). This information may also be passed as one or more parameters in a call to Import Service 108. On the occurrence of a specified event, Migration Solution 106 may extract the desired objects from ERP System 107, and package these objects (in the desired format) into one or more Case Files 105.

Migration Solution 106 may be implemented using a number of different technologies, such as iWay Adaptive Framework, Sitrion Systems iNET.Integrator, or SAP NetWeaver. However, according to various embodiments, Migration Solution 106 may not use any one of these technologies. Migration Solution 106 may also be implemented as native programming code, such as C#, C++, JAVA, or the like, and interfaced to the existing Application Programming Interfaces (APIs) within the ERP System.

As explained above, Migration Solution 106 may be configured to monitor the ERP System 107 dynamically. Moreover, according to various embodiments, Migration Solution 106 may be configured to interact with ERP System 107 in “batch” mode (e.g., to look at the existing classes of objects within ERP System 107 and perform operations on these objects). It is also possible to configure Migration Solution 106 to interact with ERP System 107 in both dynamic and batch modes (e.g., to perform a batch operation on existing objects and also monitor the ERP System 107 on an ongoing basis for the creation of objects).

As also illustrated by FIG. 1, an Administrator, through Graphic User Interface 101, may use Rules Editor 102 to create one or more Rules Files 104 (an example of which is illustrated in Appendix B). Like Migration Toolkit 103, Rules Editor 102 is a design-time tool that is used to create Rules Files 104. Rules Editor 102 may be implemented using any number of existing applications, such as Microsoft BizTalk or K2 Workflow, or can be implemented using custom code in, for example, C#, C++, JAVA, or any other suitable programming language.

According to various embodiments, Rules Files 104 provide one or more sets of instructions to Import Service 108 (e.g., a run-time element) pertaining to actions to be applied to the data contained in Case File 105. These Rules Files 104 may be represented, for example, in XML. Rules Files 104 may also contain some knowledge about the data classification, storage, and retention rules (the “Fileplan”) that exists in the EDRM System.

Using Rules Editor 102, an Administrator may create a Rules Files 104 from scratch, or may select preconfigured Rules Files 104 and then adapt those files to meet specific needs. After they are created, Rules Files 104 are passed to Import Service 108.

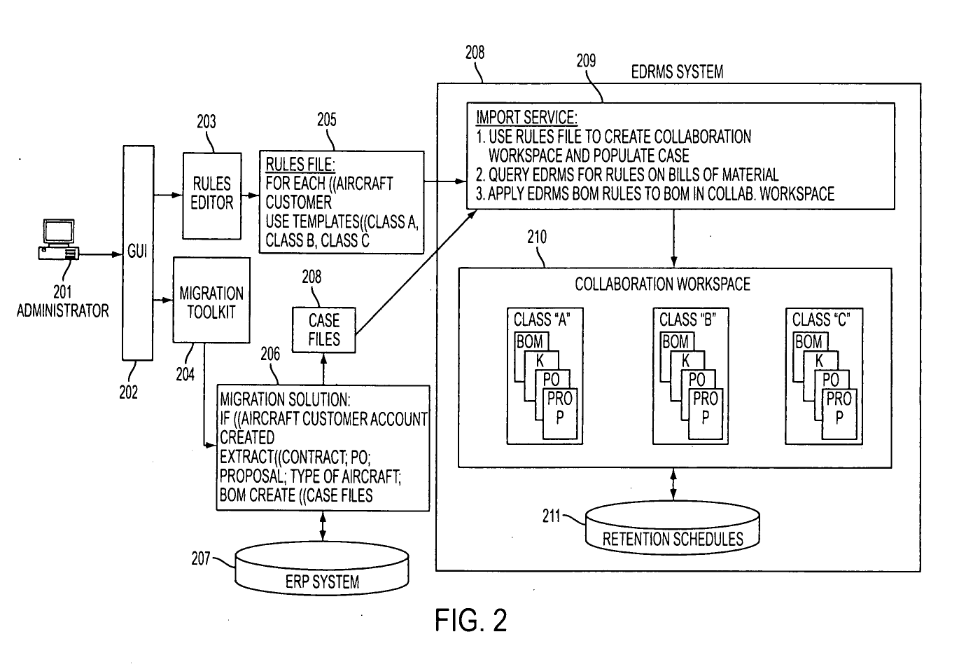

In FIG. 2, some details are provided regarding the parameters that an Administrator 201 may set for Migration Solution 206 using Migration Toolkit 204. As illustrated, Administrator 201 in FIG. 2 may, through GUI 201 and Migration Toolkit 204, instruct Migration Solution 206 to monitor ERP System 207 for the addition of a new Aircraft Customer Account. Upon the creation of an Aircraft Customer Account, Migration Solution 206 may extract, for example, the following information from the Customer Account within ERP System 207: the contract text, the purchase order, the proposal and the Classes of Aircraft the Customer has indicated it wishes to purchase under the Customer Account, along with the Bill of Materials for any preliminary orders placed by the Customer.

As illustrated in FIG. 2, Administrator 201 may select a preconfigured class of instructions corresponding to an Aircraft Customer. As also illustrated in FIG. 2, Administrator 201 may further select sub-classes of instructions corresponding to the classes of Aircraft the Customer is intending to purchase (e.g., in this case, Class A, Class B, and Class C).

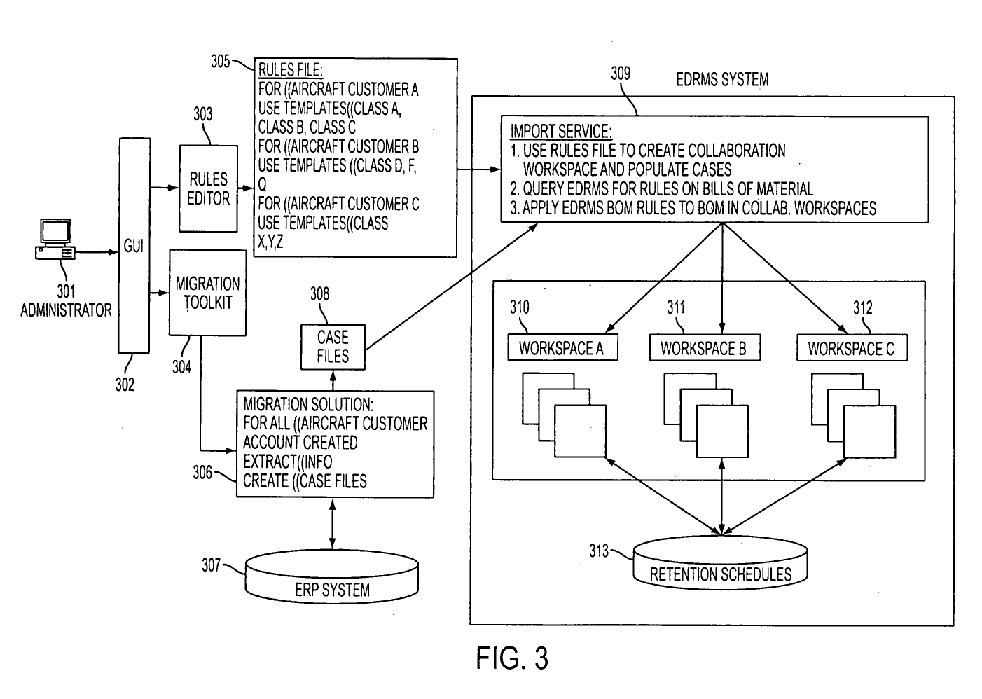

Referring back to FIG. 1, an Administrator may use Migration Toolkit 103 to configure Migration Solution 106 to monitor ERP System 107 for the happening of a specified event or the creation of a specified object. Although, in the example illustrated in FIG. 2, Migration Solution 206 is instructed to respond only to the creation of a New Aircraft Customer Account, it may also be configured to conduct a “batch” operation on ERP System 207 and extract all Aircraft Customer Account information in a single operation. An example of such an operation is detailed in FIG. 3.

In FIG. 3, instead of instructing Migration Solution 306 to monitor ERP System 307, Administrator 301 may use Migration Toolkit 304 to instruct Migration Solution 306 to assume that one or more events have happened (e.g., that the Customer account or accounts have already been created), and to extract the relevant information for all existing events that correspond to an Aircraft Customer account. In this manner, a new user of an embodiment of the invention according to FIG. 3 who may already have, for example, several dozen customers or objects within its ERP System 307 may use the Migration Solution 306 to extract this information and make it available to the EDRM system.

Referring again to FIG. 1, upon the happening of a predefined event or the creation of an object in ERP System 107, Migration Solution 106 may respond to that event or the creation of an object by extracting the requested information from ERP System 107 and creating an XML package of data called a Case File 105. According to various embodiments, Migration Solution 106 passes this information to the next stage in the process, involving Import Service 108. In the example in FIG. 1, this information is passed to Import Service 108 using the TCP/IP protocol. However, it will be understood that any suitable communication protocol may be used to pass this information to Import Service 108.

Continuing with FIG. 1, according to various embodiments, Case File 105 and Rules Files 104 are passed to the Import Service 108. Import Service 108 is responsible for taking Case File 105 (or Case Files 105) and processing it according to the rules contained in Rules Files 104. Based on the rules, Import Service 108 uses the APIs of the EDRM System 109 to create and adjust objects in EDRM System 109. According to various embodiments, Import Service 108 is an abstract machine with two essential characteristics, which are the abilities to interpret the rules presented by a Rules File 104 and communicate with EDRM System 109 to determine whether EDRM System 109 will apply storage, retention, disposal, or other criteria to any of the objects or documents contained in a particular Case File 105. It will be understood that, while only basic interaction with EDRM System 109 is described above, it is possible for Import Service 108 to have more detailed interaction with EDRM System 109 or any other suitable system, such as an email system, a database system, etc. For example, Import Service 108 may also instruct EDRM System 109 to adjust retention policies on items based on changes to the status of the customer account, to set up a new Microsoft SharePoint or Lotus Notes team site to handle collaboration relating to a new item and to link the team site to a folder within the fileplan of the EDRM System 109, or to trigger a workflow in the EDRM System 109 corresponding to an event with the ERP System 107. Likewise, with an email system, Import Service 108 may send one or more emails (e.g., notifying of the creation of a customer account) upon the occurrence of an event. Similarly, Import Service 108 may modify a database (e.g., create a row or a table to store ERP data) upon the occurrence of an event.

Import Service 108 shown in FIG. 1 may use the parameters from Rules Files 104 and apply those parameters to the information contained in Case File 105 to create a Collaboration Workspace within EDRM system 109. For example, Import Service 108 interprets the Rules File 104 created by the Administrator and creates a collaboration space within EDRM system 109 based on rules contained within the Rules File 104. For example, this may include creating classes and files corresponding to the Fileplan that exists within EDRM system 109. It may also query EDRM system 109 to determine whether there are specific policies within EDRM system 109 that may be applicable to the information contained in the Collaboration Workspace 109a. These policies may include, but are not limited to, the retention schedule applicable to the particular record, any associated disposal schedules, permissions process triggers, and the like.

Referring again to FIG. 2, an example of the operation of Import Service 209 in creating Collaboration Workspace 210 is provided. For example, Import Service 209 may interpret Rules Files 205 and create the profile of an Aircraft Customer. Import Service 209 may also create sub-classes corresponding to the classes of Aircraft the Customer is intending to purchase (e.g., in this case Class A, Class B, and Class C). This is the beginning of the Collaboration Workspace. Next, according to various embodiments, Import Service 209 may populate the profiles and sub-classes with electronic documents/records. Because Import Service 209 has also received Case Files 208, it may have also extracted one or more of the following information from the Case Files 208 presented to it: the contract text, the purchase order, the proposal, and the Classes of Aircraft the Customer has indicated it wishes to purchase under the Customer Account, along with the Bill of Materials for any preliminary orders placed by the Customer. Under each sub-template, Import Service 209 may place the Bill of Materials for each sub-class within the template for such sub-class.

Referring still to FIG. 2, Import Service 209 may then query EDRM system 208 and apply the appropriate parameters from EDRM system 208 to the records in the Collaboration Space. In this case, for example, EDRM system 208 may require that Bills of Material for each class of Aircraft be retained within the EDRM system 208 for a certain period of time (e.g., six years from delivery of the aircraft to the customer) before they are securely deleted. Import Service 209 interprets this requirement and adds these parameters to the Bills of Material within each sub-template in the Collaboration Space.

According to various embodiments, Import Service 209 may be independent of ERP system 207. In this case, Import Service 209 does not need to know what type of system sits at the beginning of the process. Rather, Import Service 209 needs only to have a set of rules from the Rules File 205 instructing it regarding what form of structure to set up within the Collaboration Space, raw XML data from the Case File, and data management parameters from the EDRM system.

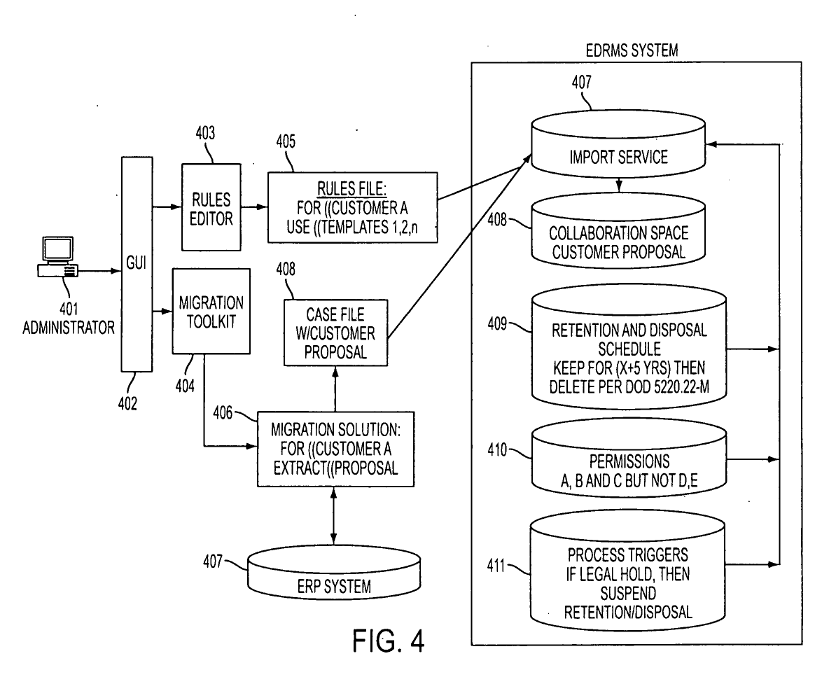

It will be understood that the parameters that may be applied to the Collaboration Space may consist of parameters other than the simple disposal schedule that is illustrated in FIG. 2. For example, referring now to FIG. 4, a more detailed example is provided regarding the interaction between a Collaboration Space 408 and other elements of an EDRM system.

According to the embodiment represented by FIG. 4, in response to the creation of a new customer account, data is extracted in XML format, and a Collaboration Space within the EDRM system to contain the data is created. For example, as illustrated by FIG. 4, one of the objects that has been placed in the Collaboration Space may be the text of the initial Customer Proposal for Customer A. Within the EDRM system, there are several items associated with Customer Proposals, such as access permissions, a document retention and disposal schedule, and process triggers. In this example, the process trigger is what is sometimes known as a “Legal Hold.” For example, on the initiation of litigation, the EDRM system may override the document retention and disposal schedule to ensure that, while the litigation is pending, key documents and other electronic records are preserved.

Once it is made aware that one or more Customer Proposals are within the Collaboration Space, Import Service 407 may query the EDRM system and extract the rules that are applicable to customer proposals. In the case represented by FIG. 4, the EDRM system limits access to Customer Proposals to classes A, B, and C of users, but not classes D or E. The EDRM system may also have retention and disposal schedules for Customer Proposals requiring customer proposals be kept for a period of, for example, five (5) years following the expiration or termination of the customer contract, following which the proposal (and any copies which might exist within the EDRM system) may be securely deleted according to any suitable standard, such as US Department of Defense standard 5220.22-M.

APPENDIX A
(Example Case File)

| <?xml version=“1.0” ?> | |
|---|---|
| − | <client-engagement> |

<client-name>Dekker Associates</client-name>
<client-number>120357</client-number>
<client-address1>100 Wilkes Plaza</client-address1>
<client-address2>Chicago</client-address2>
<client-address3>IL 20534</client-address3>
<client-phone>203-345-7007</client-phone>
<client-manager>Becky James</client-manager>
<engagement-type>Market Analysis</engagement-type>
<engagement-title>Evaluation of Dekker Opportunities in

Offshore Utility Support</engagement-title>

</client-engagement>

APPENDIX B
(Example Rules File)

<?xml version=“1.0” ?>
− <client-engagement-rules>

− <rule>

− <make-folder>

<folder-root-location>Client Engagements</folder-root-

location>

<folder-subroot-location>$YEAR-$MONTH</folder-

subroot-location>

| | <folder-parent>$client-manager</folder-parent> |
|---|---|
| | <folder-name>$client-name</folder-name> |
| − | <folder-metadata> |

<client-name>$client-name</client-name>
<client-number>$client-number</client-number>
<client-address1>$client-address1</client-

address1>

<client-address2>$client-address2</client-

address2>

<client-address3>$client-address3</client-

address3>

<client-phone>$client-phone</client-phone>
<engagement-type>$engagement-

type</engagement-type>

<engagement-title>$engagement-

title</engagement-title>

</folder-metadata>

</make-folder>

</rule>
− <rule>
− <add-forms>

<folder-root-location>Client Engagements</folder-root-

location>

<folder-subroot-location>$YEAR-$MONTH</folder-

subroot-location>

<folder-parent>$client-manager</folder-parent>
<folder-name>$client-name</folder-name>
<form>Client NDA</form>
<form>Client Contract</form>
<form>Client Key Personnel</form>

</add-forms>

</rule>

</client-engagement-rules>

Other embodiments, extensions, and modifications of the ideas presented above are comprehended and should be within the reach of one versed in the art upon reviewing the present disclosure. Accordingly, the scope of the present invention in its various aspects should not be limited by the examples presented above. The individual aspects of the present invention, and the entirety of the invention should be regarded so as to allow for such design modifications and future developments within the scope of the present disclosure. The present invention is only limited by the claims which follow.

What is claimed is:

1. A method for creating a collaboration space using information from an Enterprise Resource Planning (ERP) system, comprising:
defining at least one event to monitor in the ERP system;
defining the information from the ERP system to be captured;
defining actions to be applied to the information; and
upon the occurrence of the at least one event, extracting the information from the ERP system and performing the actions on the information to create the collaboration space.

2. The method of claim 1, wherein the event is the creation of a new customer account.

3. The method of claim 1, wherein the event is the creation of an order for an item.

4. The method of claim 1, wherein the event is the receipt of a purchase order.

5. The method of claim 1, wherein the event is a change in customer data.

6. The method of claim 1, wherein the information is contract text.

7. The method of claim 1, wherein the information is a purchase order.

8. The method of claim 1, wherein the information is a proposal.

9. The method of claim 1, wherein the information describes an item to be purchased.

10. The method of claim 1, wherein the information is describes a bill of materials for an order.

11. The method of claim 1, wherein the actions apply classifications to the information.

12. The method of claim 1, wherein the actions define storage policies for the information.

13. The method of claim 1, wherein the actions define retention rules for the information.

14. The method of claim 1, wherein the actions define disposal rules for the information.

15. The method of claim 1, wherein the actions apply different templates to different information.

16. The method of claim 15, wherein the different information is different customers.

17. The method of claim 1, further comprising assuming the event has occurred.

18. The method of claim 1, wherein the action to be applied to the information is defined by at least one rule.

19. The method of claim 1, further comprising modifying a database in response to the occurrence of the at least one event.

20. The method of claim 1, further comprising sending an email in response to the occurrence of the at least one event.

21. A system for creating a collaboration space using information from an Enterprise Resource Planning (ERP) system, comprising:
an interface to the ERP system; and
a processor that:
defines at least one event to monitor in the ERP system;
defines the information from the ERP system to be captured;
defines actions to be applied to the information; and
upon the occurrence of the at least one event, extracts the information from the ERP system and performing the actions on the information to create the collaboration space.

22. The system of claim 21, wherein the event is the creation of a new customer account.

23. The system of claim 21, wherein the event is the creation of an order for an item.

24. The system of claim 21, wherein the event is the receipt of a purchase order.

25. The system of claim 21, wherein the event is a change in customer data.

26. The system of claim 21, wherein the information is contract text.

27. The system of claim 21, wherein the information is a purchase order.

28. The system of claim 21, wherein the information is a proposal.

29. The system of claim 21, wherein the information describes an item to be purchased.

30. The system of claim 21, wherein the information describes a bill of materials for an order.

31. The system of claim 21, wherein the actions apply classifications to the information.

32. The system of claim 21, wherein the actions define storage policies for the information.

33. The system of claim 21, wherein the actions define retention rules for the information.

34. The system of claim 21, wherein the actions define disposal rules for the information.

35. The system of claim 21, wherein the actions apply different templates to different information.

36. The system of claim 35, wherein the different information is different customers.

37. The system of claim 21, wherein the processor assumes the event has occurred.

38. The system of claim 21, wherein the action to be applied to the information is defined by at least one rule.

39. The system of claim 21, wherein the processor also modifies a database in response to the occurrence of the at least one event.

40. The system of claim 21, wherein the processor also sends an email in response to the occurrence of the at least one event.

41. A computer-readable medium containing computer-executable instructions that, when executed by a processor, cause the processor to perform a method for creating a collaboration space using information from an Enterprise Resource Planning (ERP) system, the method comprising:
defining at least one event to monitor in the ERP system;
defining the information from the ERP system to be captured;
defining actions to be applied to the information; and
upon the occurrence of the at least one event, extracting the information from the ERP system and performing the actions on the information to create the collaboration space.

42. The medium of claim 41, wherein the event is the creation of a new customer account.

43. The medium of claim 41, wherein the event is the creation of an order for an item.

44. The medium of claim 41, wherein the event is the receipt of a purchase order.

45. The medium of claim 41, wherein the event is a change in customer data.

46. The medium of claim 41, wherein the information is contract text.

47. The medium of claim 41, wherein the information is a purchase order.

48. The medium of claim 41, wherein the information is a proposal.

49. The medium of claim 41, wherein the information describes an item to be purchased.

50. The medium of claim 41, wherein the information is describes a bill of materials for an order.

51. The medium of claim 41, wherein the actions apply classifications to the information.

52. The medium of claim 41, wherein the actions define storage policies for the information.

53. The medium of claim 41, wherein the actions define retention rules for the information.

54. The medium of claim 41, wherein the actions define disposal rules for the information.

55. The medium of claim 41, wherein the actions apply different templates to different information.

56. The medium of claim 55, wherein the different information is different customers.

57. The medium of claim 41, wherein the method further comprises assuming the event has occurred.

58. The medium of claim 41, wherein the action to be applied to the information is defined by at least one rule.

59. The medium of claim 41, further comprising modifying a database in response to the occurrence of the at least one event.

60. The medium of claim 41, further comprising sending an email in response to the occurrence of the at least one event.
